(19) United States
(12) Patent Application Publication
(10) Pub. No.: US 2022/0199278 A1
(43) Pub. Date: Jun. 23, 2022

(54) STABILIZED GRATING STRUCTURES

(71) Applicant: KONINKLIJKE PHILIPS N.V., EINDHOVEN (NL)

(72) Inventors: THOMAS KOEHLER, NORDERSTEDT (DE); BERND RUDI DAVID, GRUNBERG (DE); GEREON VOGTMEIER, AACHEN (DE); PAULUS RENÉ MARIA VAN BEERS, EINDHOVEN (NL); SVEN PETER PREVRHAL, HAMBURG (DE)

(21) Appl. No.: 17/612,612

(22) PCT Filed: May 21, 2020
(86) PCT No.: PCT/EP2020/064206

§ 371 Date: Nov. 19, 2021

(30) Foreign Application Priority Data
May 27, 2019 (EP) 19176734.2

(51) Int. Cl. G21K 1/06

(52) U.S. Cl. CPC G21K 1/06; G21K 2201/067; G21K 2201/064; G21K 2207/005

(57) ABSTRACT

A grating structure is provided with arc-shaped stabilizing bridging structures on the lamellae that allow for bending the grating to account for stresses and deformations induced by the bending process to obtain a more stable curved grating structure more efficiently.

### FIELD OF THE INVENTION

The present invention generally relates to a grating structure, an interferometer arrangement, a phase contrast and/or dark field x-ray imaging system and a method for constructing a bridge-stabilized grating structure.

### BACKGROUND OF THE INVENTION

Grating structures are often used in optical applications, most commonly as diffraction gratings comprising a series of parallel lamellae with a periodic structure that split and diffract light passing through the grating.

In many applications the distance between the lamellae of the grating is very small. The distance between each neighboring lamella needs to be exactly the same to obtain a desired optical effect without distortions or other inaccuracies. When this distance is reduced to (far) sub-millimeter dimensions this becomes increasingly difficult to achieve with current manufacturing methods. With micromachining, etching or other micro-manufacturing techniques it is currently possible to obtain highly regular dense grating structures. However manufacturing cost strongly increases with increased density.

Furthermore, often at the same time the aspect ratio of the lamella is very large (e.g. 100 or larger). This causes difficulty in manufacturing, particularly to align the lamellae with the required high accuracy. The higher the aspect ratio, the larger the chance that lamellae may tilt or bend, thereby reducing the optical quality or even (locally) eliminating the functionality, resulting in defects in the pattern.

A known solution to prevent tilting, bending or otherwise collapsing of high aspect ratio gratings is to construct stabilizing structures between the lamellae. FIG. 1 shows two known examples of such stabilizing structures. FIG. 1a shows bridging structures 30 at regular intervals between neighboring lamellae 10, as is for instance known from J. Kenntner et. al in ‘Fabrication and Characterization of Analyzer Gratings with High Aspect Ratios for Phase Contrast Imaging Using a Talbot Interferometer’, AIP Conference Proceedings 1437 (2012), pages 89-93. These bridging structures may extend along the whole depth of the lamellae or may be at discreet positions, e.g. at the top or overlaid over the lamellae. There may be only one or multiple regularly or irregularly located bridging structures 30 between two neighboring lamellae. FIG. 1b shows an alternative stabilizing structure 30, a so-called sunray structure comprising of stick-like structures penetrating multiple lamellae, as is for instance known from WO2012055495A1 which introduces polymer bridges. In both cases the stabilizing structures 30 are preferably of a different material than the lamellae and have a different (or no) absorption for the wavelength of radiation emitted by the radiation source.

Construction of the stabilizing features interferes with the lithographic manufacturing steps of metal gratings, as they are manufactured using different techniques that need to be performed simultaneously or alternatingly. In an interesting alternative solution bridges are added on top of the grating after it has been manufactured, as is shown schematically in FIG. 2. First lamellae (e.g. metal lamellae, such as gold or bismuth) of a grating are manufacturing using regular lithographic techniques to the desired height, see FIG. 2a. For instance, a source grating (G0) of a Talbot-Lau interferometer usually with a trench of about 4 micron requires a height of 250 to 300 microns if the grating is made of gold, while for other x-ray absorbing materials this may even increase to 350-400 micron, meaning an aspect ratio from at least about 60 to about 100 or more is needed for this application. During this described process the resist material is preferably still present between the lamellae (not shown in the figure for clarity reasons) as this ensures stability during the process, but it could conceivably also be performed with the resist material already removed from between the grating lamellae.

Next, small grooves 11 are introduced at the top of the lamellae 10, e.g. by laser cutting or ablation, as is shown in FIG. 2b. Shape and dimensions of the grooves 11 may vary, e.g. flat, curved or slanted edges and/or shallow or deeper grooves. The grooves 11 are applied with an amount and periodicity that balances as low as possible x-ray absorption and optimal structural integrity of the grating as a whole. In case the resist structure is still present then also the grooves are also structured in there.

Next, thin, elongated strips of a material 30 are applied, and optionally bonded, in the grooves 11 extending over several lamellae 10, as is shown in FIG. 2c. The strips 30 may for instance be applied using any technique available to the skilled person, for instance using an electroplating process. Metal bridges, such as gold or nickel, provide the most stability and structural integrity, while polymer bridges are usually more transparent to incoming radiation. In applications where hard radiation, such as x-ray radiation, is used, polymer bridges are likely less suitable as they degrade during use.

As a final step the resist material, if present, is removed using common lithographic and etching techniques to obtain a stabilized grating structure.

Such resulting gratings are suitable for use as diffraction gratings in flat arrangements. However, for some important applications a radiation source emits radiation, such as visible light, x-rays or gamma rays, in a non-straight manner. A common example is a radiation source emitting radiation in a cone beam or fan beam, whereby the radiation beam has a fan or cone shape. Each radiation path has a different distance and angle towards a target surface. When one wants to use a diffraction grating in such a non-straight beam shape, then the diffraction grating must be curved according to the geometry of the beam. FIG. 3 shows an exemplary manufacturing method of such curved gratings that is most common. In this method, a straight grating 10, for instance one such as shown in FIG. 2c, attached to substrate 20. The substrate is bended until the correct angular position of the lamellae of the grating is obtained, as is shown in an exemplary sketches in FIG. 3. Depending on the bending direction a convex grating 10 (FIG. 3b) or a concave grating 10 (FIGS. 3c (side view) and 3d (perspective view)) is obtained.

The bending, in both directions, causes high mechanical stresses in the bridging structures 30 that are likely deform plastically. This may cause severe structural instability of the grating. Also, the grating period may become inhomogeneous due to varying ‘pulling’ or ‘pushing’ forces of the stabilizing bridged on the different lamellae. FIG. 3 shows an embodiment for electroplated stabilizing bridges on top of the lamellae, but the procedure of bending and the related problems thereof are also valid for other stabilizing structures.

### SUMMARY OF THE INVENTION

It is an object of the invention obtain curved gratings with reduced mechanical stress in the stabilizing structures.

In a first aspect of the claimed invention a grating structure comprises a grating. The grating comprises a plurality of lamellae connected with a first end to a substrate. Neighboring lamellae of the plurality of lamellae are connected on a second end, at the opposite side of the lamellae than the first end, by at least one stabilizing bridging structure. The at least one stabilizing bridging structure forms a single, distinct arc-shape between two neighboring lamellae. Such distinct arc-shaped stabilizing bridging structures between two neighboring lamellae allow for more stretch during bending than known flat bridging structures, thereby reducing or even eliminating plastic deformation.

When the term ‘bridging structure’ or ‘bridge’ is used for brevity in the context of embodiments of the presently claimed invention, then it is directly implied that a ‘stabilizing bridging structure’ is meant.

In the context of the presently claimed invention the term ‘neighboring’ lamellae is understood to be two directly neighboring lamellae.

The term ‘stabilizing’ is defined in the context of the presently claimed invention as providing mechanical stability to prevent the lamellae from tilting, collapsing, bending and the like.

The term ‘single, distinct arc-shape’ is defined in the context of the present invention as a bridging structure that has a clear starting point at one lamella and a clear end point at a next lamella and that is shaped like an individual arc between said lamellae. This specifically excludes arc-shaped structures covering more than two lamellae, such as bent substrates or other structures arcing continuously and indistinctly over a plurality of lamellae wherein the start point and end point of the arc are not on two directly neighboring lamellae. The definition term ‘single, distinct arc-shape’ allows for a plurality of single, distinct arc-shaped stabilizing bridging structures that repeat for a further set of two neighboring lamellae (which may include one of the lamellae of the original pair of neighboring lamellae). Specifically this also includes bridging structures that form a continuous or similarly repeating pattern (e.g. as shown in FIGS. 4 to 6) over multiple pairs of neighboring lamellae, as long as it is clear to the skilled person that each of these neighboring pairs of lamellae each has a distinct arc-shaped stabilizing bridging structure.

In an embodiment the grating is curved in a concave or convex direction. Depending on the application and light beam shape a grating bended in a concave or convex may be appropriate.

In an embodiment the arc-shaped bridging structure includes at least one arc-shaped section that arcs away from the plurality of lamellae. Simultaneously or alternatingly at least one arc-shaped section that arcs into the plurality of lamella. Depending on grating dimensions and lamellar spacing an inwardly or outwardly directed bridging structure may be appropriate.

In an embodiment the at least one bridging structure is constructed of the same material as the lamellae of the grating. Preferably said material is a metal, more preferably gold or bismuth. This simplifies grating production as all or part of the production equipment may be used to construct the grating lamellae and the bridging structures. And, as the grating material and bridging structure material are the same they are optimally compatible, which may improve or facilitate bonding optimally. Gold and Bismuth are materials that highly absorb (x-ray) radiation, but also can be formed or machined precisely and relatively easy.

In an embodiment along a length of the grating a row of bridging structures forms a continuous structure across all lamellae, preferably in a strip configuration. As such a bridging structure extends over a length of the grating, which allows for manufacturing a full strip at once.

In an embodiment multiple bridging structures are connected to the second end of the lamellae at different regular or irregularly spaced positions. In practical gratings multiple bridging structures are required for optimal stability. An advantage of a regular pattern is that correcting in (post)-processing for shadowing due to the bridges is simpler, while an irregular pattern has the advantage that the interference is averaged and therefore a more homogenous result is obtained compared to a regular pattern.

In an embodiment the at least one bridging structure covers less than 5% of a surface area of the grating, preferably less than 3% of the surface area of the grating. The less bridging structures are present, the less loss in x-ray transmission.

A further aspect of the presently claimed invention is directed towards an interferometer arrangement comprising at least on grating structure as claimed.

A further aspect of the presently claimed invention is directed towards a phase contrast and/or dark field x-ray imaging system comprising an interferometer arrangement as claimed, preferably arranged in a Talbot-Lau configuration. Such an interferometric imaging system would optimally benefit from the a stable bended grating, since the gratings in such imaging systems need to accommodate a x-ray radiation emitted in a fan-beam or cone-beam.

In an embodiment the lamellae have an aspect ratio of greater than 50 micron, greater than 100 micron or greater than 200 micron and/or wherein the lamellae of a source grating G0 of the Talbot-Lau interferometer are spaced apart, at the first section with a distance of less than 10 micron, preferably between 6 and 9 micron, more preferably between 7 and 8 micron and/or the lamellae of an analyzer grating G2 of the Talbot-Lau interferometer are spaced apart, at the first section with a distance of less than 30 micron, preferably between 10 and 30 micron, more preferably about 15 micron. These are particularly suitable dimensions for use in a Talbot-Lau interferometer of a phase contrast or dark field imaging system.

A further aspect of the presently claimed invention is directed towards a method for constructing a bridge-stabilized grating structure comprising a grating comprising a plurality of lamellae placed with a first end on a substrate. Said method comprises the steps of: (a) providing a resist negative grating on a substrate, preferably by a lithographic process; (b) filling the resist negative structure with a grating material, preferably by electroplating; (d) applying at least one bridging structure (30) on a second end, at the opposite side of the lamellae than the first end, between two directly neighboring lamellae of the grating structure, wherein the bridging structure is pre-processed to having an arc-shape or is processed after application to the lamellae to obtain an arc-shape; (e) removing the resist negative grating, preferably by etching. This method is fully compatible with known lithographic or etching manufacturing processes.

In an embodiment the method includes prior to step (e) the step of (c) pre-processing the lamellae of the plurality of lamellae to receive the at least one bridging structure, for instance by introducing at least one recess in the second end of at least one of the lamellae. This allows for improved alignment precision and bonding between the grating lamellae and the bridging structures.

In an embodiment the bridge structures are processed to become arc-shaped by mechanical bending, etching or laser ablation. These are particularly suitable production processes to machine the bridging structure material into the desired arc-shape.

In an embodiment the method further comprises the step of (0 bending the grating structure. As such a curved grating with increased stability is obtained.

A further aspect of the presently claimed invention is directed towards a method for constructing an interferometer, comprising the steps of providing a plurality of gratings, wherein at least one of the plurality of gratings is a grating structure of the presently claimed invention and arranging the plurality of gratings in an interferometric arrangement, preferably a Talbot-Lau interferometric arrangement.

Still further aspects and embodiments of the present invention will be appreciated by those of ordinary skill in the art upon reading and understanding the following detailed description. Numerous additional advantages and benefits will become apparent to those of ordinary skill in the art upon reading the following detailed description of preferred embodiments.

### BRIEF DESCRIPTION OF THE DRAWINGS

The present invention is illustrated by drawings of which

FIG. 1 shows examples of gratings with known stabilizing structures.

FIG. 2 shows a schematic overview of a process in which stabilizing bridges are applied on top of a grating.

FIG. 3 shows schematic examples of a known grating structure prior to and after bending.

FIG. 4 shows schematic examples of different arc-shaped bridges according to the presently claimed invention.

FIG. 5 shows schematic examples of a grating structure according to the presently claimed invention prior to and after bending.

FIG. 6 schematically shows intermediate products of a manufacturing process to obtain a curved grating structure according to the present invention.

FIG. 7 shows a flowchart of a process to obtain a curved grating structure according to the present invention.

FIG. 8 shows a schematic depiction of a phase contrast imaging set-up using curved grating structures.

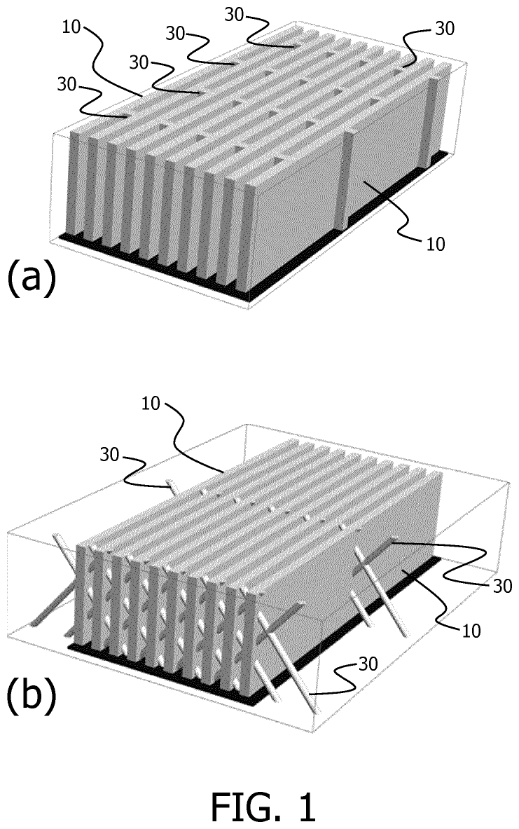

The invention may take form in various components and arrangements of components, and in various process operations and arrangements of process operations. The drawings are only for the purpose of illustrating preferred embodiments and are not to be construed as limiting the invention. To better visualize certain features may be omitted or dimensions may be not be according to scale.

### DETAILED DESCRIPTION OF EMBODIMENTS

An underlying insight that lies at the base of the currently claimed invention is that it would be beneficial that during bending the stabilizing structures 30 do not leave the elastic regime. This reduces or even eliminates plastic deformation and the associated problems as described previously.

It was further realized that this may be achieved by abandoning straight and/or flat stabilizing structures of the known art and use non-flat, particularly arc-shaped, stabilizing structures instead.

A basic, schematic side-view of an embodiment of a grating according to the presently claimed invention is shown in FIG. 5. A grating 10 comprising of a row of lamellae is mounted on a substrate 20. Stabilizing bridges are applied on top (i.e. at the opposite side of the substrate) of the lamellae. FIG. 5a shows an embodiment wherein the stabilizing bridge 30 arcs away from the lamellae of the grating 10, while FIG. 5d shows an embodiment in which the stabilizing bridge 30 arcs (at least partly) in between lamellae of the grating 10.

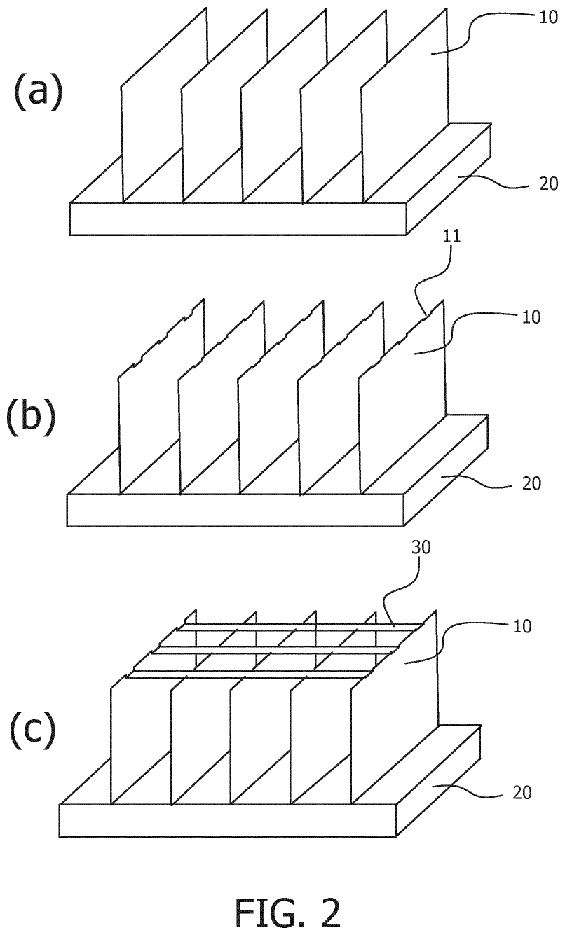

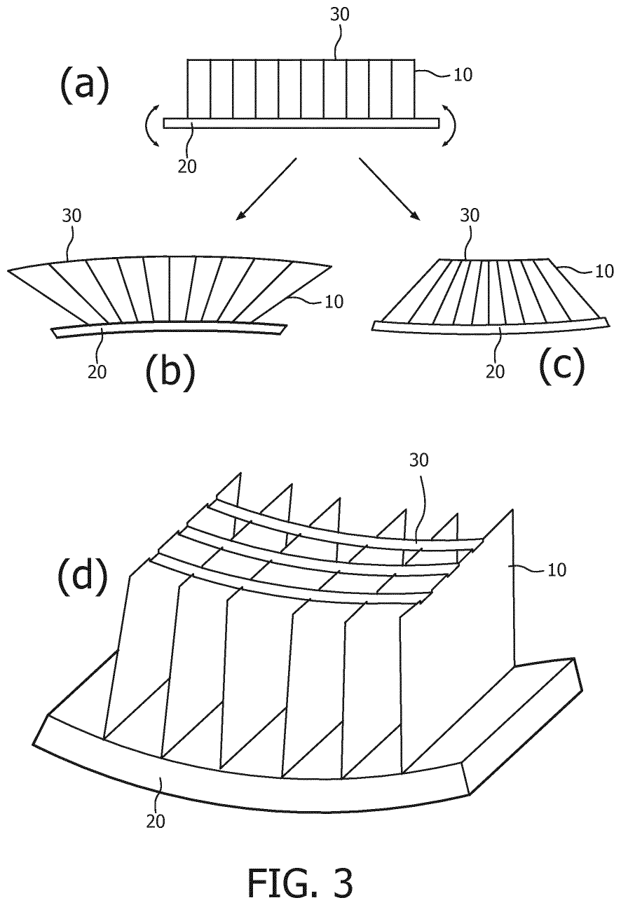

The stabilizing bridges are electroplated on the lamellae as described previously in relation to FIG. 2 or applied using any other suitable technique. The stabilizing bridge 30 as shown in FIGS. 5a and 5d extends across the whole length of the grating as a strip. Other options are also possible, as long as each bridge connects at least two neighboring lamellae.

The amount and density of the stabilizing bridges 30 should be at an optimum between high mechanical strength, high stability and low radiation absorption. Preferably the bridging structure 30 covers less than 5% of a surface area of the grating 10 and more preferably less than 3% of the surface area of the grating.

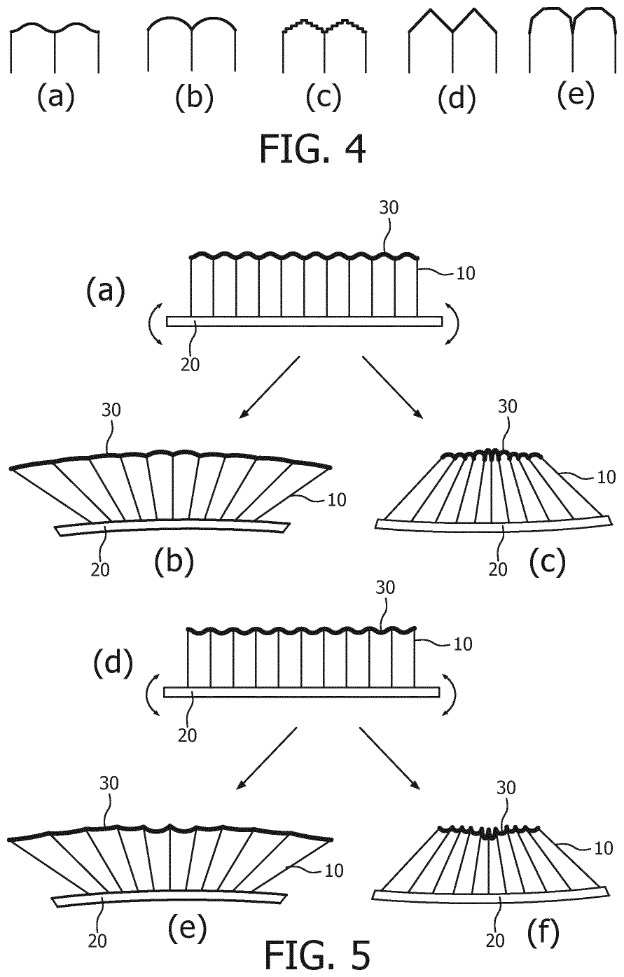

The stabilizing bridges may have a ‘sinewave-like’ configuration as is shown in FIG. 4, but they also may be a row of discrete semi-circular or semi-elliptical arcs bridging a gap between two neighboring lamellae. Furthermore, it should be understood that in the context of the presently claimed invention the term ‘arc’ or ‘arc-shaped’ specifically also includes other continuous and non-continuous arc-like structures as is illustrated in FIG. 4, such as sinusoidal (FIG. 4a), circular/elliptical (FIG. 4b), stepwise linear (FIG. 4c), triangular (FIG. 4d), trapezoid and/or other polygonal (FIG. 4e) structures, wherein one single, distinct bridging structure is defined as an arc-shape structure bridging between to lamellae with a clear begin and end point, even if the bridging structure continues smoothly into the next bridging structure (i.e. without a jump or other change in tangent, such as in the sine-wave example of FIG. 4a and FIGS. 5 and 6). These are non-limiting examples and any other suitable non-flat structure is incorporated, including inverted versions, as well as combinations of different arc-shapes used in one grating structure.

For increased stability a plurality of stabilizing bridges 30 is applied to the grating 10. These may have a regular or irregular pattern. An advantage of a regular pattern is that correcting in (post)-processing for shadowing due to the bridges 30 is simpler, while an irregular pattern has the advantage that the interference is averaged and therefore a more homogenous result is obtained compared to a regular pattern. Further, with an irregular pattern there is somewhat less change of missing features of interest, particularly when the imaging subject is imaged from different angles during a procedure. Preferably, for optimal compatibility and homogeneity, the bridging structures (30) are of the same material as the lamellae of the grating 10, preferably a metal, such as gold or bismuth.

FIGS. 5b and 5e depict the grating structure bended to a convex configuration, while FIGS. 5c and 5f depict the grating structure bended to a concave configuration. Due to the arced shape of the stabilizing bridges 30 deform on bending. The radius of the arcs is not drawn to scale with respect to the lamellae, they may be larger or smaller.

In the convex grating configuration the arced bridges stretch and flatten, which causes the bridge itself to dissipate any deformation forces instead of the lamellae of the grating 10.

In the concave configuration the arced bridges deform into more strongly arced structures. While this may actually increase deformation forces and encounter spatial hindrance, particularly for a configuration as shown in FIG. 5f or similar inwardly directed arcs, this may be at least somewhat mitigated by choosing a smaller arc radius or a different bridge geometry (e.g. by changing the material thickness). Also using other types of materials may be contemplated.

In both configurations the material of the stabilizing bridges must be flexible enough to allow deformation within the elastic regime. However the material must not be too flexible such that it may deform plastically, as this may influence long-term stability due to relaxation of the material.

When a curved grating according to the invention as claimed is used in a cone-beam then the convex configuration is preferably such that an incoming radiation beam first enters the grating structure before the substrate 20, while the substrate 20 is chosen for its transparency for the wavelength of the incoming radiation beam, there is nearly always some attenuation and/or scatter that may influence the diffractive pattern and reduce the quality of the grating. However, the concave configuration is likely easier to manufacture and more stable over time. However in this case the grating should be placed in a cone-beam or fan-beam such that the radiation first encounters the substrate 20 before the grating structure, which may (slightly) reduce the diffraction pattern quality.

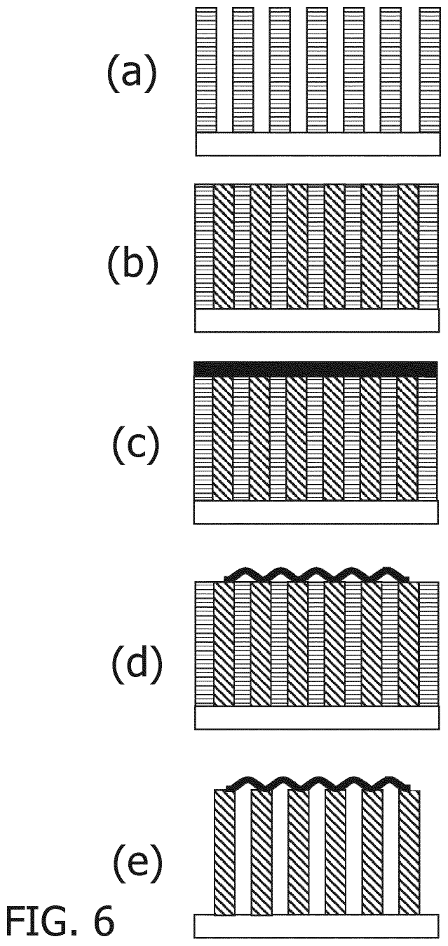

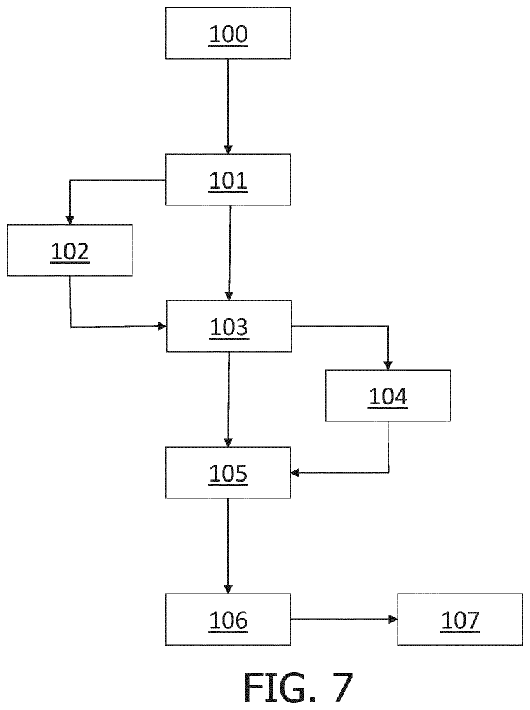

FIG. 6 depicts a schematic depiction of a production process to form a grating structure having arc-shaped bridging structures 30. A flowchart of this process is shown in FIG. 7.

First a substrate 20 with a resist negative grating 40 is provided (100), as is shown in FIG. 6a. The substrate 20 may for instance be a silicon waver covered with a metal, for instance oxidized titanium that is treated chemically and by plasma. Other materials for covering the silicon substrate are possible too, for instance other (treated) metals, as long as it provides the silicon substrate with a good interface with the resist material and for use as a seed layer for electroplating later in the procedure. The resist negative structure 40 may be formed to the desired height (e.g. 50 microns, 100 microns, 150 microns, 200 microns or any other height that is achievable in a stable manner) on the substrate using a lithographic process on a resist material that is applied to the substrate 20.

Next, the negative resist structure 40 is filled (101) with a material that will form the grating 10, as is shown in FIG. 6b. Usually these are strongly radiation-absorbing metals such as gold or bismuth. The most common way to fill such materials is by electroplating.

The top of the grating 10 is optionally pre-processed (102) to receive the stabilizing bridges, e.g. by introducing small and shallow grooves as shown in and described in relation with FIG. 2.

Next, the stabilizing bridges (30) are applied (103) to the top of the grating 10. The bridging structure 30 may be applied (103) as a pre-formed arced structure (see FIG. 6d) or, preferably, as a substantially flat layer (as is shown in FIG. 6c) that is machined (104) after application to the grating (10) to obtain the arc shapes. An advantage of pre-formed arced bridging structures 30 is that they may be precisely manufactured beforehand that will not have influence on the formed grating 10, e.g. damaging the structure 10 during machining causing expensive drop-outs in the production process. However, precise placement and alignment of such pre-formed arced structures may be complex. An advantage of forming the arc structures after placement on the grating 10 is that application of the bridge structures is relatively simple, e.g. by electroplating metal (e.g. gold, bismuth, nickel or other metals that can be deposited in a controlled manner and that have sufficient x-ray absorption in thin layers) bridges. High-precision machining tools, such as laser ablation tools, may be used to form the final bridging structure 10 in a fast, accurate and stable manner without a high risk for damaging the grating 10.

Finally the negative resist structure 40 is removed (105), e.g. by etching to obtain a grating 10 with arced bridges 30 between neighboring lamellae, as is shown in FIG. 6e. The process may be adapted in a straightforward manner to obtain bridges that do not span the entire grating structure and/or have a more random distribution.

Next, the grating structure may be brought into a curved geometry by bending (106) the substrate 20. This may be achieved by mounting the substrate 20 in a mechanical holder or frame with a predefined radius or by clamping the sides of the substrate 20 and moving them upwards or downwards while the center substrate 20 is fixedly secured.

The curved grating structure may then be incorporated and/or applied (107) in an application by itself or in combination with more bended gratings.

A particularly interesting application that utilizes curved gratings is phase contrast imaging, such as dark-field x-ray imaging (DAX) and differential phase contrast imaging (DPCI), provide high sensitivity to phase-gradients and scattering structures in the object and are a promising addition to diagnostic or analytical (x-ray) imaging, for instance for medical diagnoses, material analysis and security scanning.

Phase contrast imaging (this term is used throughout this document to cover both DAX and DPCI) is an imaging technique that only recently found practical use in medical x-ray imaging. Phase contrast imaging has already been long known for visual optics, but for x-ray imaging it was restricted to highly brilliant synchrotron x-ray sources that are not suitable for medical imaging due to their size and very limited energy band width and angular divergence. However, a grating-based solution was developed to generate dark field x-ray images using x-ray tubes commonly used in medical imaging. See for instance: Pfeiffer et. al., “Hard-X-ray dark-field imaging using a grating interferometer”, Nature Materials, Vol. 7, February 2008, page 134-137].

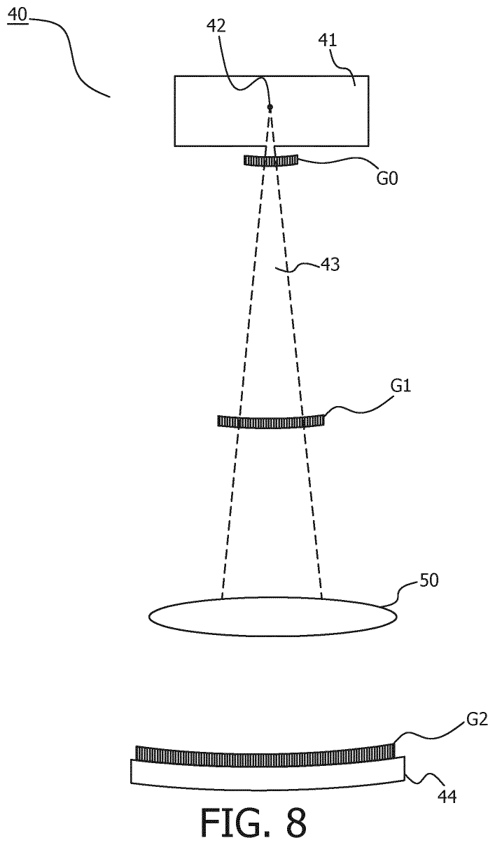

Such grating-based phase contrast imaging may be performed using a phase contrast set-up 10 as is schematically depicted in FIG. 8. This set-up is called a Talbot-Lau interferometric arrangement. An X-ray beam 43 is emitted from an x-ray focal spot 42 of an x-ray source 41. A first grating structure G0, commonly named the source grating, is placed close to the focal spot 42. Because of the source grating G0 the radiation beam 43 is in effect divided into an array of line sources splitting up the beam into separate parallel beams, which then pass through a second grating structure G1, commonly named the phase grating, which may be placed in front (e.g. for computed tomography (CT) imaging), or behind (e.g. for standard x-ray imaging) a subject 50 to be imaged. The x-ray beam 43 passes a third grating structure G2, commonly named the analyzer grating, before it is detected by a detector 64, in which imaging information is generated and transmitted to processing equipment (not shown). Both the phase grating G1 and the analyzer grating G2 contribute to image contrast, wherein the phase grating G1 causes periodic spatial phase modulations in the x-ray beam 43. By propagation of the partially coherent x-rays, the phase modulation is transformed into an intensity modulation which has a typical period in the range of 5-50 μm (Talbot effect). The analyzer grating G2 then transforms the high-frequency intensity modulations into a low-frequency intensity modulation. When the phase grating G1 or the analyzer grating G2 is moved transversely with respect to the radiation beam 43, the x-ray intensity detected oscillates in each pixel of the detector 44, wherein the magnitude of the oscillations is determined by the subject 50. These local intensity changes may then be used to determine dark field and phase contrast image data, which are obtained simultaneously.

In the example shown in FIG. 8 all gratings G0, G1, G2 are curved gratings, but also embodiments where only one or two of the gratings G0, G1, G2 are curved are possible. Also variations on the Talbot-Lau interferometer set-up are possible, e.g. without the analyzer grating G2 in case optical resolution of the detector is sufficient to resolve the phase data.

The obtained dark field image data represents scatter information of the x-ray beam 43 through the subject 50. This scatter data is obtained simultaneously with x-ray transmission image data, which provides attenuation measurement data, particularly of a difference between high and low absorption areas, and with phase contrast image data, which provides increased soft-tissue contrast, which makes it particularly suitable for imaging ‘soft’ materials with many surface area transitions and/or micro-structures (e.g. lungs, fibrous materials and the like).

The obtained differential phase contrast image represents refractive index information of the x-ray beam 43 through the subject 50. This may be advantageously used, on its own or in combination with the simultaneously obtained transmission image, to enhance image contrast by using detailed differing refractive index changes within structures that are otherwise uniform.

The presently claimed invention is of particular use for phase contrast imaging, as the optical and mechanical requirements are very demanding. For instance, a typical source grating G0 has an active area between 2×2 cm and 6×6 cm, a pitch distance between lamellae in the range of 7-8 micron with an aspect ratio of at least 50-60 for gold lamellae and potentially up to or over 100 for other materials, whereby 3-5% of the overall area is covered by the (preferably non-regularly placed) stabilizing bridges 30. For other gratings in a Talbot-Lau interferometer the pitch distance and/or lamellar height may be different. For instance, for the analyzer grating G2, they would be larger, than that of the source grating G0: a pitch distance of between 10 and 30 micron, depending on the system dimensions, preferably about 15 micron. Because of this grating manufacturing for this purpose is extremely expensive. The currently claimed gratings are less likely to be rejected during manufacturing due to quality problems and/or provide higher quality diffractive properties than those that were bended using known methods. As such more cost-effective, high-quality gratings are obtained that are suitable for phase contrast imaging and other optical applications.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage.

The term ‘about’ or ‘approximately’ means within a range of 10% above or below the stated value, preferably within a range of 5% above or below the stated value, and more preferably within a range of 1% above or below the stated value.

1. A grating structure for X-ray phase contrast imaging and/or X-ray dark-field imaging, the grating structure comprising:
a grating comprising a plurality of lamellae connected with a first end to a substrate, wherein neighboring lamellae of the plurality of lamellae are connected on a second end, at the opposite side of the lamellae than the first end, by at least one stabilizing bridging structure, wherein the at least one stabilizing bridging structure forms a single, distinct arc-shape between two neighboring lamellae.

2. The grating structure according to claim 1, wherein the grating is curved in a concave or convex direction.

3. The grating structure according to claim 1, wherein the arc-shaped stabilizing bridging structure includes at least one arc-shaped section that arcs away from the plurality of lamellae and/or at least one arc-shaped section that arcs into the plurality of lamella.

4. The grating structure according to claim 1, wherein the at least one stabilizing bridging structure is constructed of the same material as the lamellae of the grating.

5. The grating structure according to claim 1, wherein along a length of the grating a row of stabilizing bridging structures forms a continuous structure across all lamellae.

6. The grating structure according to claim 1, wherein multiple stabilizing bridging structures are connected to the second end of the lamellae at different regular or irregularly spaced positions.

7. The grating structure according to claim 1, wherein the at least one stabilizing bridging structure covers less than 5% of a surface area of the grating.

8. An interferometer arrangement comprising at least one grating structure according to claim 1.

9. (canceled)

10. A phase contrast and/or dark field imaging system according to claim 1, wherein the lamellae of the grating structure have an aspect ratio of greater than 50 micron, greater than 100 micron or greater than 200 micron, and/or wherein the lamellae of the grating structure forming a source grating G0 of the Talbot-Lau interferometer are spaced apart, at the first section with a distance of less than 10 micron, and/or wherein the lamellae of the grating structure forming an analyzer grating G2 of the Talbot-Lau interferometer are spaced apart, at the first section with a distance of less than 30 micron.

11. A method for constructing a bridge-stabilized grating structure comprising a grating for X-ray phase contrast imaging and/or X-ray dark field imaging, the grating comprising a plurality of lamellae placed with a first end on a substrate, the method comprising:
providing a resist negative grating on a substrate;
filling the resist negative structure with a grating material;
applying at least one stabilizing bridging structure on a second end, at the opposite side of the lamellae than the first end, between two directly neighboring lamellae of the grating structure, wherein the stabilizing bridging structure is pre-processed to having an arc-shape or is processed after application to the lamellae to obtain an arc-shape;
removing the resist negative grating.

12. The method according to claim 11, further comprising:
pre-processing the lamellae of the plurality of lamellae to receive the at least one stabilizing bridging structure by introducing at least one recess in the second end of at least one of the lamellae.

13. The method according to claim 11, wherein the stabilizing bridge structures are processed to become arc-shaped by mechanical bending, etching, or laser ablation.

14. The method according to claim 11, further comprising:
bending the grating structure.

15. The method for constructing an interferometer, comprising:
providing a plurality of gratings, wherein at least one of the plurality of gratings is a grating structure according to claim 12; and
arranging the plurality of gratings in an interferometric arrangement.

16. The grating structure according to claim 1, wherein the stabilizing bridging structure is shaped like an individual arc between the neighboring lamellae, such that the same arc shape does not extend indistinctly and continuously to a further lamella beyond the two neighboring lamellae, and wherein the arc-shaped stabilizing bridging structure is adapted to elastically deform by flattening and/or flexing more strongly to dissipate deformation forces acting on the lamellae.
